(19) United States
(12) Patent Application Publication
(10) Pub. No.: US 2002/0107757 A1
(43) Pub. Date: Aug. 8, 2002

(54) System and method for automated selection and delivery of gifts

(76) Inventors: William T. Evans, Batesville, AR (US); J. Robert Lemon, Batesville, AR (US); Timothy A. Nolan, Batesville, AR (US); Robert Christian, Batesville, AR (US)

Correspondence Address: COLEMAN SUDOL SAPONE, P.C., 714 COLORADO AVENUE, BRIDGEPORT, CT, 06605-1601, US

(21) Appl. No.: 10/045,618

(22) Filed: Oct. 23, 2001

Related U.S. Application Data
(60) Provisional application No. 60/242,636, filed on Oct. 23, 2000.

(51) Int. Cl. G06F 17/60

(52) U.S. Cl. 705/26

(57) ABSTRACT

A system and method for the automated delivery of gifts uses a computer system to obtain user and sender data and provides for the sending of health care products as gifts.

This application claims priority in U.S. Provisional Patent Application No. 60/242,636 filed Oct. 23, 2000.

### TECHNICAL FIELD

This invention relates to a system and method for use by assisting individuals in selecting and sending gifts and more particularly to an automated system for preparing and sending personalized gift packages which include health care products.

### BACKGROUND

Gift giving is a long standing tradition, generally related to celebrating or marking certain events. Typically, a person will search for and select an appropriate gift, wrap the gift or otherwise prepare it in a decorative fashion and then deliver the gift either in person or by mail.

For many individuals, it is difficult to find the time to search for and select an appropriate gift, or to find the time to adequately decorate and personalize the gift. Further, many gifts lack utility for the receiver such as the much lampooned tie that is never worn in public. What is needed is a gift selecting and delivery system that offers a coordinated selection of prepackaged items as gifts, that are useful to the recipient yet which include a degree of personalization to show the sender's regard for the recipient.

It is an object of the present invention to provide a system and method for selecting and delivering gifts to a recipient that is simple and easy to use.

It is a further object of the present invention to provide a system and method that utilizes vitamin, mineral and nutritional supplements, as well as related health and cosmetic products, as the basis for the gift.

It is a further object to provide a system and method that personalizes the gift selection and delivery of the gift, as well as allowing the recipient to acknowledge the gift in a simple manner.

These and other objects of the present invention are achieved by a system comprising a group of health care products, means for a sender to select an appropriate subset of the group of health care products to be sent to the recipient as a gift, means for inputting user and sender data and for storing the data, means for assembling and packaging the gift in a gift package, means for generating a gift card using the user and recipient data and for incorporating the gift card in the gift package, means for generating a thank you acknowledgement using the user and sender data and for incorporating the thank you acknowledgement in the gift package and means for sending the gift package to the recipient.

### BRIEF DESCRIPTION OF THE DRAWINGS

FIGS. 1a and 1b together are a logic flowchart that shows the system and method of the invention.

FIG. 2 is an overall system view.

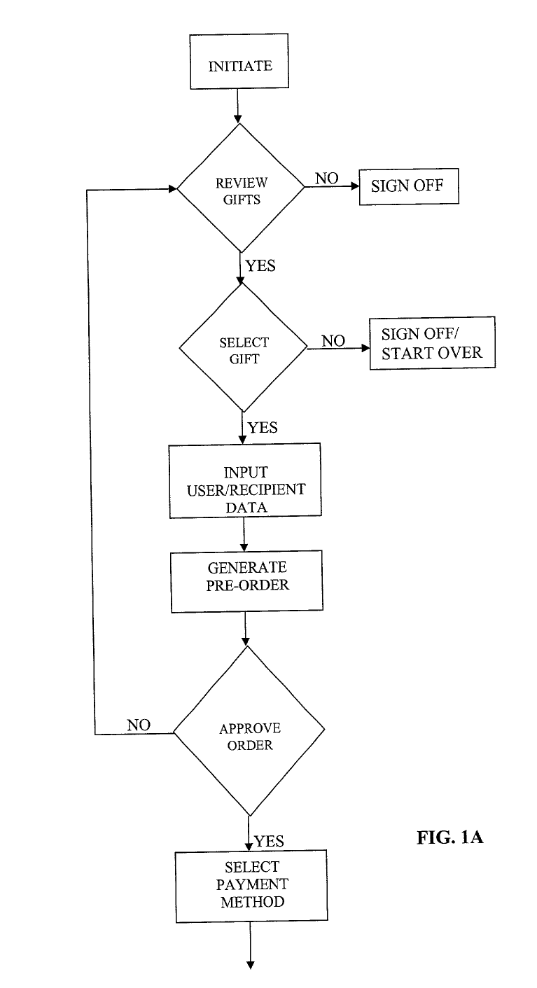

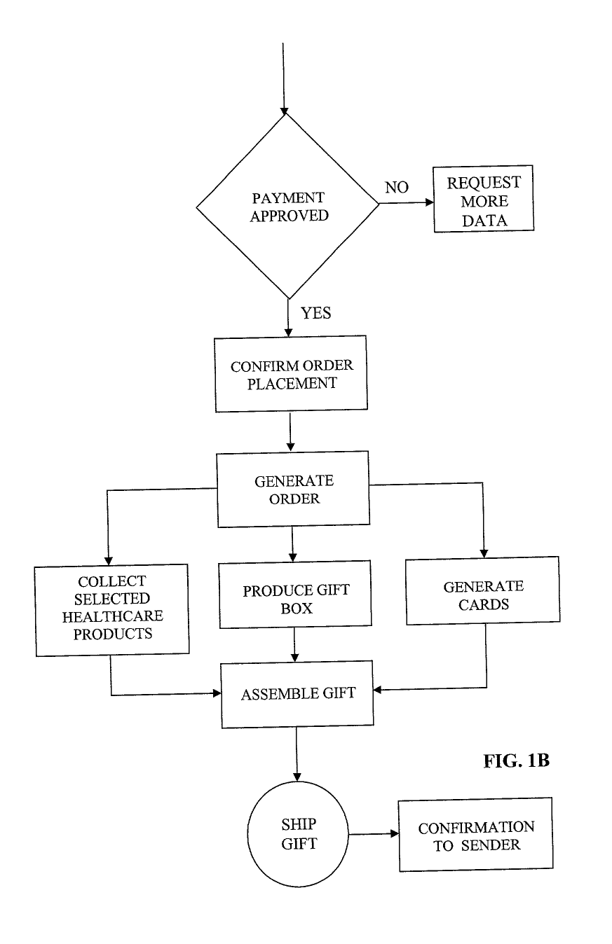

### DETAILED DESCRIPTION OF THE INVENTION

The system and method of the invention is in the form of a gift service that delivers vitamin and nutritional supplements and related health and cosmetic products as gifts. Such products are generally not considered by many individuals as being suitable as gifts, mainly because they are packaged, marketed and sold for a buyer's consumption. Yet such products are in fact a very appropriate gift as they can be very useful to the recipient and show the sender's concern for the health and well-being of the recipient.

One difficulty for a sender is the large variety of possible products and potential combinations. It has thus been difficult for a sender, even desiring to give such products as gifts, to select appropriate ones as well as to package them in a way which dresses up the usually utilitarian packaging of such products to enhance their look so as to convey the value of the products as a gift.

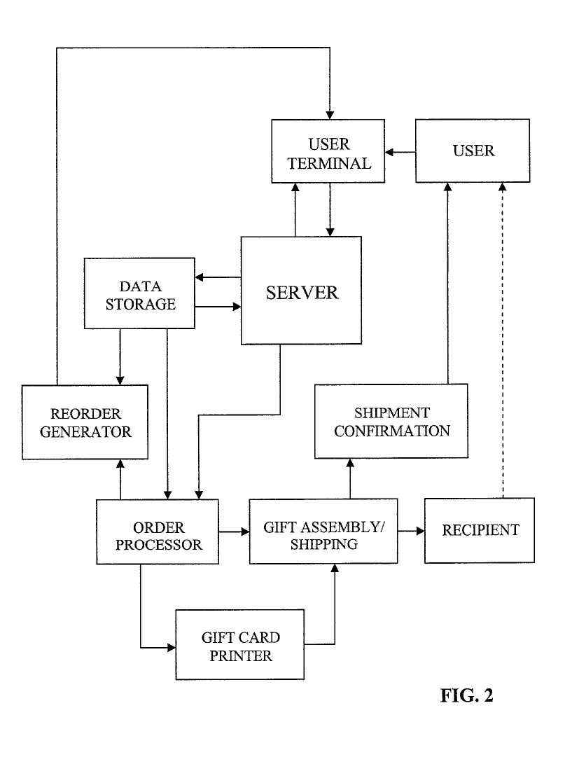

In accordance with the present invention, various vitamins and nutritional supplements are selected to form a group of gift products, each product having labeling related to delivering the products as gifts, with preselected subsets of the group assembled to serve as appropriate gifts for various age/sex individuals, and desired price of the gift, to simplify the selection process. Generally, from two to ten products can be selected to form a subset which can be sent as a gift. From two to six and more preferably two to four products are included in each subset group. An exemplary list of subsets, referred to as product packs, is shown in FIG. 2.

By providing a select set of product groupings designed for particular age/sex groups, the user has available a ready list of appropriate gifts. Thus, a user desiring to send such a gift initiates contact, possibly via the Internet, and inputs the users' information and recipient's information. This may be done via a questionnaire that can be faxed or mailed to the gift service but more preferably is done via web pages on the Internet.

The user then reviews the list of possible gift combinations and if one is appropriate, this is selected. The user then selects a payment option, and once payment is approved and/or confirmed, the order is processed. First, a gift package is assembled and a personalized gift card generated and disposed in the gift box. The select grouping of products is assembled and placed in the gift box. A thank you acknowledgment such as a card is automatically generated and included in the gift box, both the gift card and thank you card being personalized to reflect the information obtained via the user questionnaire. The gift box is then mailed or shipped via the type of carrier selected by the user to assure delivery on a user selected date. A confirmation is generated to advise the user that the gift has been sent. optionally, the gift can be a continuing one such as to provide for shipment on a monthly, quarterly, bi-annual or annual basis. This is particularly useful with health products which must be replaced as the product is consumed. This can be done automatically should the user desire to do this at the time the order is first processed, or can be done on approval by the automatic generation of reminders sent to the user, which allow for confirmation for re-sending of the same gift or allow the user to revise the gift to allow more or less products to be sent.

Using the present invention, a new personalized automated delivery service for providing vitamin and nutritional supplements and related health and cosmetics as gifts is provided to present a recipient with a useful selection of products in a manner convenient to both the sender and recipient, with means for personalizing the gift and simplifying the thank you process.

In one embodiment of the invention, the gift service delivers nutritional supplements in a gift pack, with the gift packs consisting of two, three or four product packs. The user has the option to customize a two, three or four product pack, and can choose to send individual products instead of a pack. Upon delivery, the recipient receives a customized gift box which has the gift card on top with a personalized sentiment from the giver, if one was provided by the user in the entry questionnaire. The gift pack will include an explanation of the gift that was chosen so as to describe the components of the gift pack which is also personalized with the sender and recipients' names. Beneath this they will find the products themselves as well as a blank thank you note addressed back to the sender of the gift which is both addressed and has the appropriate postage so that the recipient can write a short note of thanks back to the giver and simply drop the thank you note in the mail.

Optionally, the gift pack may include additional information on the gift service so that the recipient may take advantage of the service to send similar gifts to others.

In addition, once the gift is sent to the recipient, a letter is generated and mailed to the user to confirm that the gift has been sent.

As an option, if designated as a continuing gift, that is, one automatically prepared and sent on a scheduled basis, the user will receive a letter automatically generated which reminds the user that their gift has likely been consumed, or the due date for shipment is near, and to request if they wish to reorder and resend the products to the recipient. This can be done on a monthly, quarterly, biannual or annual basis. While the gift service is most preferred to be made available via a website so as to simplify customer ordering online, this service can also be provided via a catalog with orders and the questionnaire answers completed by phone, or via a print form that is mailed or faxed back to the gift service, which then adds the data collected to a computer system for processing.

While various specific products have been described herein it will be understood that there are a number of possible vitamin, mineral and nutritional products, and other relate health care and cosmetic products, which can be included in such gift packs and that the following particular list shown in this application is merely illustrative, and the health care products list can be expanded considerably.

Health Care Product Group, by Type

Weight management; stress and anxiety relief; mental function; antioxidant; prostate support; joint and bone support; immune system support; anti-aging; general nutritional support; vitamins; minerals; nutritional supplements; digestion; circulation and heart support; metabolism; etc.

Of course, there are many herbal and natural product formulations that combine ingredients that promote combined effects among these types, such as the oligomeric proanthocyanadins which are antioxidants, useful for circulation support and anti-aging. In any event virtually any such herbal and natural health care product could be used in the present invention, and the invention is not limited to any one type of health care product.

Illustrative Health Care Product Packs

Packs for Young Adults

1) Vitamin and mineral supplement & antioxidant 2) Vitamin and nutritional supplement, Antioxidant & Mental function support 3) Vitamin and nutritional supplement, antioxidant, mental function & metabolism booster

Packs for Young Women

1) anti-aging & antioxidant 2) anti-aging, anti-oxidant & circulation support 3) anti-aging, anti-oxidant, circulation support & joint and bone support

Packs for Young Men

1) Circulation support & anti-oxidant 2) Circulation, anti-oxidant & metabolism booster 3) Circulation, anti-oxidant, metabolism booster & prostate support

Packs for Women

1) joint and bone support & anti-aging 2) joint and bone support, anti aging and anti-oxidant 3) joint and bone support, anti-aging, anti-oxidant & mental function

Packs for Age Men

1) Prostate support & Circulation 2) Prostate support, circulation & anti-oxidant 3) Prostate support, Circulation, anti-oxidant & mental function

Customized Packs:

1) any 2 Product Customized Pack 2) any 3 Product Customized Pack 3) any 4 Product Customized Pack

1. A system comprising a group of health care products, means for a sender to select an appropriate subset of the group of health care products to be sent to the recipient as a gift, means for inputting user and sender data and for storing the data, means for assembling and packaging the gift in a gift package, means for generating a gift card using the user and recipient data and for incorporating the gift card in the gift package, and means for sending the gift package to the recipient.

2. The system of claim 1 further comprising means for generating a thank you acknowledgement using the user and sender data and for incorporating the thank you acknowledgement in the gift package.

3. The system of claim 1 wherein the health care products are selected from the group consisting of weight management formulations; stress and anxiety relief formulations; mental function formulations; antioxidant formulations; prostate support; joint and bone support; immune system support; anti-aging; general nutritional support; vitamins; minerals; nutritional supplements; digestion; circulation and heart support; metabolism; and combinations thereof.

4. A method for the automated delivery of gifts comprising providing a group of health care products, providing means for a sender to select an appropriate subset of the group of health care products to be sent to the recipient as a gift, inputting user and sender data and storing the data, assembling and packaging the gift in a gift package, generating a gift card using the user and recipient data and incorporating the gift card in the gift package, and sending the gift package to the recipient.

5. The method of claim 4 further comprising generating a thank you acknowledgement using the user and sender data and incorporating the thank you acknowledgement in the gift package.
